(19) United States
(12) Patent Application Publication
(10) Pub. No.: US 2012/0118650 A1
(43) Pub. Date: May 17, 2012

(54) DEVICE FOR POSITIONING A CONTAINER FOR A GRAVITY-FED INTRAVENOUS FLUID DELIVERY SYSTEM

(76) Inventor: Stacey GILL, Seattle, WA (US)

(21) Appl. No.: 13/152,594

(22) Filed: Jun. 3, 2011

Related U.S. Application Data
(60) Provisional application No. 61/413,625, filed on Nov. 15, 2010.

(51) Int. Cl. G01G 19/00; H01F 7/02; F16B 45/00; F16M 13/02

(52) U.S. Cl. 177/245; 248/205.1; 248/206.5

(57) ABSTRACT

A device that is suited to suspend a container of IV fluid away from a vertical surface such that the device easily mounts to the vertical surface. One embodiment includes a first (horizontal) member having a first end and a second end. Then, a second (vertical) member having a first end is attached to the first end of the first horizontal member. Further, the vertical member may be suited to be attached to a vertical surface via an attachment means, such as a hook hole or magnets. In other embodiments, the first and second members are designed to fit over the top of a door. Additionally, the device includes a hanging apparatus (e.g., a hook) attached to the second end of the first member such that an object may be suspended from the hook away from the vertical surface.

### PRIORITY CLAIM

This application claims priority to the U.S. Provisional Patent Application No. 61/413,625 entitled “I.V. DRIP CLIP” filed on Nov. 15, 2010, the entirety of which is incorporated herein by reference.

### BACKGROUND

Gravity-fed intravenous fluid delivery systems (commonly referred to as an “IV Drip”) utilize gravity to deliver fluid from a suspended container to deliver location that is positioned lower than the container of fluid. Typically, the delivery location is a human being's circulatory system, hence the term “intravenous” wherein a needle is positioned in a vein on a person's arm or leg wherein substances are delivered directly into a vein. Therapies administered intravenously are often called specialty pharmaceuticals and may be commonly referred to as a drip because many systems of administration employ a drip chamber (e.g., a suspended container), which prevents air entering the blood stream (air embolism) and allows an estimate of flow rate. Intravenous therapy may be used to correct electrolyte imbalances, to deliver medications, for blood transfusion or as fluid replacement to assist with, for example, dialysis. Compared with other routes of administration, the intravenous route is a fast way to deliver fluids and medications throughout the body.

With a suspended container, a conventional manner of suspending the container may be using an IV drip stand. An IV drip stand may include a base that supports a pole that extends high enough in a vertical direction such that a suspended container may be suspended higher than the intravenous injection point in the person receiving therapy. The IV stand, however, is cumbersome and bulky as it must necessarily be tall enough to suspend the fluid container higher than a person's arm or leg. Sometimes, one can wheel the IV stand around if the base has wheels. Further, sometimes, the IV pole may be mounted directly to a bed where the person must remain when receiving therapy. In these cases, a problem exists wherein the IV stand is less mobile in that the IV stand cannot be easily transported in a vehicle or airplane. An IV pole attached to a bed is worse for portability as very few vehicles or airplane can accommodate a hospital bed. Cumbersome and bulky IV stands are difficult to deal with when portability is needed.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 shows an isometric diagram of an apparatus for suspending an IV container according to an embodiment of the subject matter disclosed herein.

FIG. 2 shows an isometric diagram of an apparatus for suspending an IV container according to another embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

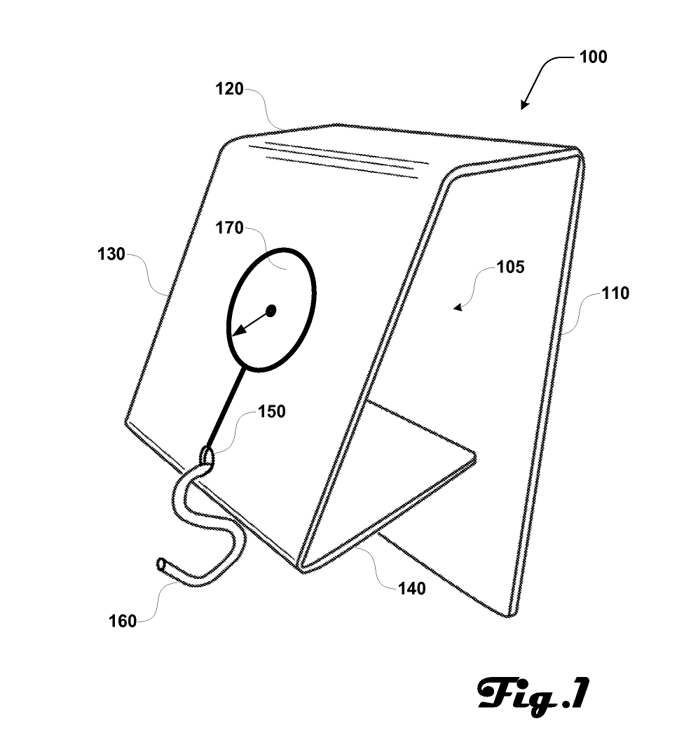

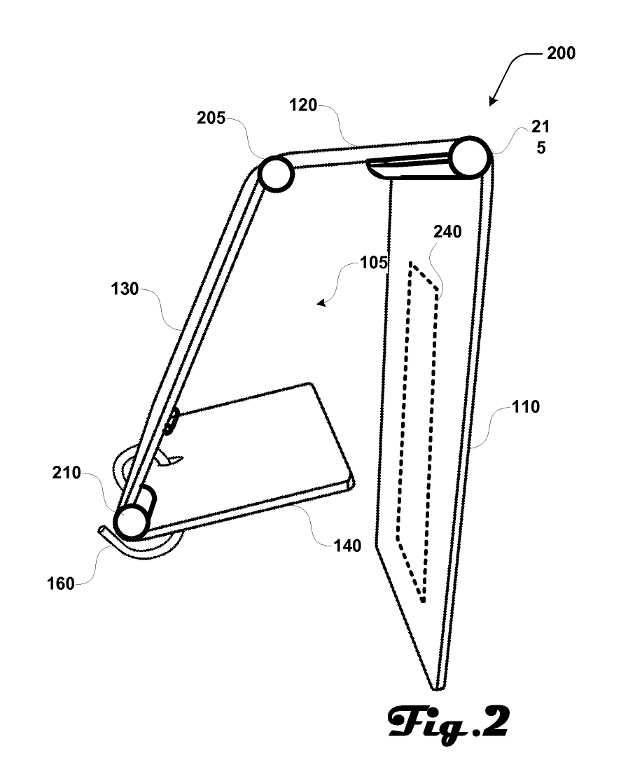

By way of overview, an embodiment as described herein includes a simple and portable device that is suited to suspend a container of IV fluid away from a vertical surface such that the device easily mounts to the vertical surface. One embodiment includes a first (horizontal) member having a first end and a second end. Then, a second (vertical) member having a first end is attached to the first end of the first horizontal member. Further, the vertical member may be suited to be attached to a vertical surface via an attachment means, such as a hook hole or magnets. In other embodiments, the first and second members are designed to fit over the top of a door. Additionally, the device includes a hanging apparatus (e.g., a hook) attached to the second end of the first member such that an object may be suspended from the hook away from the vertical surface. Some embodiments may include a second vertical member that allow the hook to be engaged further down away from the horizontal member such that the device may more securely engage the top of a door. These and other aspects are more readily understood with regard to the description below in conjunction with FIGS. 1 and 2.

FIG. 1 shows an isometric diagram of an apparatus for suspending an IV container according to an embodiment of the subject matter disclosed herein. In this embodiment the apparatus 100 may include a number of different members that are attached together to form a means for suspending an IV fluid container from a convenient location on a vertical surface, such as a wall or a door. The various members are designed to hold a suspended container (not shown) away from the vertical surface such that a gravity fed system for delivering IV fluids may be uncompromised by an IV drip bag held against a wall (e.g., a vertical surface) wherein fluid in the bag may collect in pockets and cavities formed when the IV bag may be resting against the wall.

Thus, in this embodiment, four members may be attached together to provide a simple apparatus for holding an IV drip container away from a vertical surface. A first vertical member 110 may be attached to a first horizontal member 120 at one respective end of each member. Further, the first horizontal member 120 may be attached to a first angled member 130 at the other end of the first horizontal member 120 (i.e., the end not attached to the first vertical member 110). Lastly, the fourth member, a second horizontal member 140 is attached to the other end of the first angled member 130 (i.e., the end not attached to the first horizontal member 120). In this manner, these four members form a pinch point 105 wherein a door top (not shown) may be fitted into the pinch point. That is, the apparatus 100 may be slid down on top of a door such that the pinch point engages the door top and the first vertical member 110 and a second end (the end not attached to the angled member 130) of the second horizontal member 140 engage the door from either side with a force. Thus, the device “pinches” the door top at the pinch point 105. Further, the first horizontal member 120 comes to rest on the top portion of the door top to provide additional support.

The angled member and the second horizontal member provide a suspension point 150 that may be disposed away from the vertical surface that is engaged (i.e., the door). In this manner, any fluid container suspended from the suspension point 150 may hang freely down such that the vertical surface has little or no contact with the suspended fluid container. Thus, fluid in the container cannot pool up in various crevices, recesses, and cavities as it drains to the bottom of the container and eventually through an IV tube attached to a person.

The suspension point 150 may include a hanging means such as a hook 160 to facilitate the suspension of the fluid container. As shown in this embodiment, the hanging means may be a conventional S-type hook such that the hook may be easily engaged or disengaged from both the suspended fluid container and the apparatus 100. In other embodiments, the hanging means may be a modified S-type hook that is bent closed on one end such that the hook 160 remains engaged with the apparatus 100. Still further, the hanging means may be an eye hook or a carabiner clip to facilitate additional means of attaching a suspended fluid container to the suspension point 160.

In one embodiment, the suspension point 160 may be electrically or mechanically coupled to a scale 170. Thus, any fluid container suspended from the suspension point 160 may be measured for its weight. The fluid container may then be monitored at the point of its suspension and throughout the fluid delivery therapy.

The apparatus 100 may be made from a single polyextruded plastic mold. With a plastic molded embodiment, the attachment points for the members (110, 120, 130, and 140) are contiguous and somewhat flexible. With a somewhat flexible design, stresses placed on the apparatus 100 at the attachment points of the members may be withstood and any door top that the apparatus is engaged with may be accommodated by the flexible nature of the apparatus 100. Thus, a typical door top width may be two inches, but the flexible nature of the plastic-molded apparatus may engage a door top with a tolerance of up to plus-or-minus one inch. In different embodiments, the members may be made of other materials that are more rigid and subject to withstanding greater stresses, such as aluminum or other metals.

FIG. 2 shows an isometric diagram of an apparatus for suspending an IV container according to another embodiment of the subject matter disclosed herein. In this embodiment, the members 110, 120, 130 and 140 may be attached to each other at lockable hinge points. Thus, the first vertical member 110 may be attached to a first horizontal member 120 at one respective end of each member at a first hinge point 215 that may lock at an approximately 90 degree angle. Further, the first horizontal member 120 may be attached to a first angled member 130 at the other end of the first horizontal member 120 (i.e., the end not attached to the first vertical member 110) at a second hinge point 205 lockable at an approximately 120 degree angle. Lastly, the fourth member, a second horizontal member 140 is attached to the other end of the first angled member 130 (i.e., the end not attached to the first horizontal member 120) at a third hinge point 210 that is lockable at an approximate 60 degree angle. In this manner, these four members may still form a pinch point 105 wherein a door top (not shown) may be fitted into the pinch point. Further, in this embodiment, when not engaged with a door top, the apparatus may be unlocked such that each hinge point is released and the apparatus may fold down into a flat position better suited for storage and portability.

In this and other embodiment, a different attachment means may include a magnet 240 attached to a backside of the first vertical member 110. Thus, the entire apparatus may be engaged with metal vertical surface. Those skilled in the art will understand that other means for engaging a vertical surface may include a hanging hole or suction cups for a window or window-like vertical surface.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A device, comprising:
a first member having a first end and a second end;
a second member having a first end attached to the first end of the first member, the second member suited to be attached to a vertical surface; and
a suspension point disposed at the second end of the first member such that an object may be suspended from the suspension point away from the vertical surface.

2. The device of claim 1 wherein the first and second members comprise polyextruded plastic.

3. The device of claim 1 wherein the first and second members comprise light-weight metal.

4. The device of claim 1 wherein the second member further comprises a magnet suited to be attached to a metal surface wherein the object may be suspended away from the metal surface when the magnet is engaged with the metal surface.

5. The device of claim 1, further comprising a third member coupled to the second member at the second end of the second member, the second and third members coupled at an angle that is greater than approximately 90 degrees.

6. The device of claim 5, further comprising a fourth member coupled to the third member at an angle less than approximately 90 degrees.

7. The device of claim 1, further comprising an S-hook coupled to the suspension point.

8. The device of claim 1, further comprising a weight scale electrically coupled to the suspension point.

9. The device of claim 1, further comprising a weight scale mechanically coupled to the suspension point.

10. A device, comprising:
a first member having a first end and a second end;
a second member having a first end attached to the first end of the first member at a first lockable hinge point, the second member suited to be attached to a vertical surface; and
a hook attached to the second end of the first member such that an object may be suspended from the hook away from the vertical surface.

11. The device of claim 10 wherein the first and second members comprise metal.

12. The device of claim 10 wherein the second member further comprises a magnet suited to be attached to a metal surface wherein the object may be suspended away from the metal surface when the magnet is engaged with the metal surface.

13. The device of claim 10, further comprising a third member coupled to the second member at the second end of the second member, the second and third members coupled at an angle that is greater than approximately 90 degrees.

14. The device of claim 13, further comprising a fourth member coupled to the third member at an angle less than approximately 90 degrees.

15. The device of claim 10, further comprising an eye-hook coupled to the suspension point.

16. The device of claim 10, further comprising a weight scale electrically coupled to the suspension point.

17. The device of claim 10, further comprising a weight scale mechanically coupled to the suspension point.
